(19) United States
(12) Patent Application Publication
(10) Pub. No.: US 2002/0080867 A1
(43) Pub. Date: Jun. 27, 2002

(54) Robust signaling techniques in multicarrier systems

(76) Inventors: Syed Abbas, Fremont, CA (US); Guozhu Long, Newark, CA (US)

Correspondence Address: FENWICK & WEST LLP, TWO PALO ALTO SQUARE, PALO ALTO, CA, 94306, US

(21) Appl. No.: 09/963,351

(22) Filed: Sep. 25, 2001

Related U.S. Application Data
(60) Provisional application No. 60/235,232, filed on Sep. 25, 2000.
(60) Provisional application No. 60/291,837, filed on May 18, 2001.

(51) Int. Cl. H04L 27/28; H04K 1/10; H04L 5/16; H04B 1/38

(52) U.S. Cl. 375/222; 375/260

(57) ABSTRACT

Robust techniques for signaling the likes of exit/entry into low power idle mode, bit swapping, rate adaptation, rate repartitioning and other multicarrier communication system events and control functions are disclosed.

### RELATED APPLICATIONS

This application claims the benefit of U.S. Provisional Application No. 60/235,232, filed Sep. 25, 2000, and U.S. Provisional Application No. 60/291,837, filed May 18, 2001.

### FIELD OF THE INVENTION

The invention relates to telecommunications, and more particularly, to robust signaling techniques in discrete multitone or other multicarrier-based communication systems.

### BACKGROUND OF THE INVENTION

The Telecommunications Standards Section of the International Telecommunication Union (sometimes designated as ITU-T) provides recommendations to facilitate the standardization of the telecommunications industry. Two of these recommendations are referred to as G.992.1 and G.992.2. Recommendation G.992.1 refers to an asymmetric digital subscriber line (ADSL) transceiver that is an ADSL industry standard for network access at rates up to 8.192 mbit/s downstream (towards subscriber) and 640 kbit/s upstream (towards central office or network administrator). Recommendation G.992.2, on the other hand, refers to an ADSL transceiver that is a lower data rate version of a G.992.1 ADSL transceiver. Bit rates up to 1.5 mbit/s in the downstream direction and 512 kbit/s upstream are possible with this standard.

Both the G.992.1 and G.992.2 standards apply discrete multitone (DMT) modulation technology. With DMT modulation, a communication channel between two modems is divided into a number of subchannels (also referred to as carriers or bins) for both upstream and downstream communication. During initialization between the modems, the signal-to-noise ratio (SNR) for each subchannel is obtained. The maximum bit capacity of each subchannel can then be determined. Data bits to be transmitted over each subchannel are encoded as signal points in signal constellations. Each signal constellation is then modulated onto the corresponding subchannel. Generally, the subchannels with higher SNRs are assigned more bits, and therefore have denser constellations as compared to subchannels having lower SNRs. The total number of bits transmitted by the channel is the sum of the bits transmitted by each subchannel. By working with a large number of subchannels, the overall available channel capacity is maximized thereby optimizing transmission performance.

Once the initial bitloading assignment is established, the channel's SNR profile can be monitored for changes. Changes in the channel's SNR profile may be caused by a variety of factors such as crosstalk and temperature changes. Bit swapping techniques can be employed to adjust for these changes by transferring bits from the noisier subchannels (thereby reducing their respective constellation sizes) to those subchannels having higher SNR (thereby increasing their respective constellation sizes). Such bit swapping is usually performed on a continuous basis to maintain the robustness and performance quality of the communication link. In addition to bit swapping, rate adaptation techniques can also be employed. Rate adaptation allows for occasional reconfiguring of a transmitter-receiver pair during SHOWTIME to correct for changes in the given service requirements, as well as changes in the associated channel SNR profile.

DMT ADSL modems may also employ bandwidth repartitioning (sometimes referred to as dynamic rate repartitioning) across different latency paths. Generally, non-voice applications (e.g., data applications) can tolerate a much higher amount of latency than voice applications since factors such as human hearing do not need to be accommodated. As such, it is desirable to keep voice and non-voice applications on separate latency paths that meet their respective latency requirements. Voice applications, however, require bandwidth only when a voice call is in progress. At other times, the bandwidth allocated to a voice application is unused. As such, it may be desirable to reallocate the bandwidth assigned to a currently unused latency path so that it can be used by other latency paths (e.g., data path). In this sense, the available bandwidth can be dynamically repartitioned thereby providing more bandwidth to the non-voice latency paths.

In general, features such as bit swapping, rate adaptation, and bandwidth repartitioning techniques all require changes to a number of modulation parameters. Collectively these are also known as On Line Reconfiguration (OLR). The 2^{nd} generation ADSL standards provide for an OLR protocol that allows a receiver to initiate any of the above mentioned changes through an OLR message sent over the modem overhead channel. If the proposed changes are not acceptable to the transmitter, the transmitter sends a NAK (negative acknowledge) message. Otherwise, the transmitter sends a sync flag that signals the proposed reconfiguration changes are acceptable and will take effect at a predetermined well defined time after the sync flag occurs.

Generally, the time at which the associated modulation parameter changes take effect must be signaled. One possible approach is to use sync symbol inversion to signal certain events. But this general signaling technique cannot be used in all cases. In certain cases, there is a need to have distinct robust signaling techniques to distinguish between the actions to be performed. Another possible approach is to negotiate such parameter changes (e.g., such as entry into a low power idle mode) using a message based protocol, which is robust but slow. In the case of events such as bit swapping and rate adaptation, the time when the requisite parameter changes take effect is less critical. However, the time when the parameter changes associated with dynamic bandwidth repartitioning take effect can be significant, particularly if one of the latency paths is carrying voice data. For example, if the latency (e.g., due to signaling) for a voice application exceeds 2 milliseconds, then expensive echo cancellation circuitry is required to clarify the voice application for human hearing.

Thus, there is a need for a fast and robust technique for signaling bandwidth repartitioning given the timing sensitivities associated with a latency path carrying voice data. In a more general sense, there is a need for fast, robust and distinct signaling techniques that can be used for signaling the likes of exit/entry into low power idle mode, bit swapping, rate adaptation, rate repartitioning and other such events.

### SUMMARY OF THE INVENTION

One embodiment of the present invention provides a method for signaling an event or control function in a multicarrier communication system. The method includes encoding an active state signal point in a constellation associated with a subchannel. The signal point is effectively reserved for signaling purposes. In another embodiment, the method includes encoding a symbol associated with a first symbol data pattern with a data pattern that is distinct from the first symbol data pattern and its inversion. This encoding produces a distinct signaling symbol. In another embodiment, the method includes decoding received information and detecting a constellation signal point reserved for signaling purposes in its active state. In another embodiment, the method includes decoding a distinct signaling symbol having a data pattern reserved for signaling an event or control function.

Another embodiment of the present invention provides a modem adapted to signal an event or control function in a multicarrier communication system during data mode. The modem includes an encoder module that is adapted to encode an active state signal point in a constellation associated with a subchannel. The signal point is effectively reserved for signaling purposes. In another embodiment, the modem includes an encoder module adapted to encode a symbol associated with a first symbol data pattern with a data pattern that is distinct from the first symbol data pattern and its inversion. A distinct signaling symbol is produced. In another embodiment, the modem includes a decoder module adapted to detect a constellation signal point reserved for signaling purposes in its active state. In another embodiment, the modem includes a decoder module adapted to decode a distinct signaling symbol having a data pattern reserved for signaling an event or control function.

Thus, embodiments of the present invention may be implemented, for example, in both the transmitter and receiver components of a modem pair communicating over DSL technology such as ADSL, or other multicarrier based technology. Other embodiments of the present invention provide techniques for performing initialization in a multicarrier communication system so as to facilitate deployment of the signaling techniques described herein.

The features and advantages described herein are not all inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1a is a block diagram of an ADSL transmitter that is adapted to operate in accordance with one embodiment of the present invention.

FIG. 1b is a block diagram of an ADSL receiver that is adapted to operate in accordance with one embodiment of the present invention.

FIG. 2a illustrates a relationship between subchannel capacity and signal to noise ratio in a multicarrier communication system.

FIG. 2b illustrates a 16 point constellation associated with a 4 bit subchannel.

FIG. 3a illustrates the correlation properties of the REVERB pseudo random binary sequence to its shifted versions when all subchannels are used.

FIGS. 3b and 3c illustrate the correlation properties of the REVERB pseudo random binary sequence to its shifted versions when a lesser number of subchannels is used.

FIG. 4 illustrates a method for performing necessary configuration during initialization in a multicarrier communication system to enable signaling techniques in accordance with one embodiment of the present invention.

FIG. 5a illustrates a method for signaling an event or control function in a multicarrier communication system in accordance with one embodiment of the present invention.

FIG. 5b illustrates a method for signaling an event or control function in a multicarrier communication system in accordance with another embodiment of the present invention.

FIG. 6 illustrates a method for signaling an event or control function in a multicarrier communication system in accordance with another embodiment of the present invention.

### DETAILED DESCRIPTION OF THE INVENTION

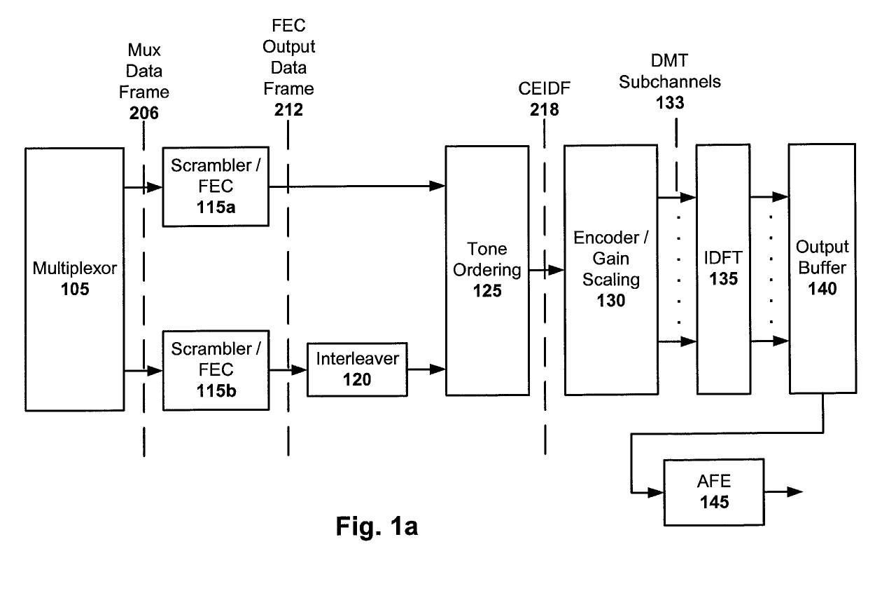

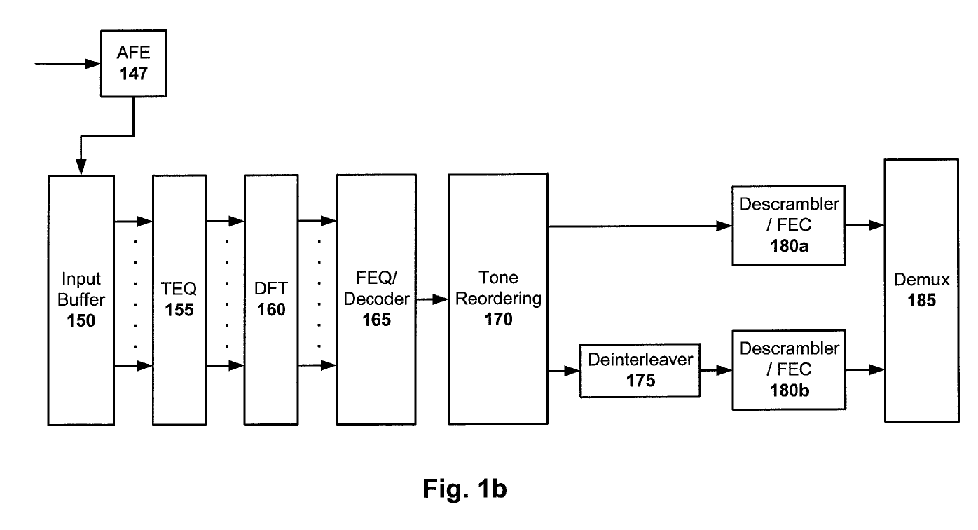

FIG. 1a is a block diagram of an ADSL transmitter that is adapted to operate in accordance with one embodiment of the present invention. The transmitter includes a multiplexor module 105, scrambler and forward error correction (FEC) modules 115a and 115b, an interleaver module 120, a tone ordering module 125, an encoder and gain scaling module 130, an inverse discrete Fourier transform (IDFT) module 135, an output buffer 140, and an analog front-end (AFE) 145. Generally, the transmitter illustrated is based on a model for facilitating understanding of transmitter function in accordance with ITU Recommendations G.992.1 and G.992.2 (collectively referred to as ADSL standards). Each of these Recommendations is herein incorporated by reference in its entirety. The operation of the present invention in the context of other standards and recommendations will be apparent in light of this disclosure.

General Overview—Transmitter

The transmitter shown in FIG. 1a may be deployed in either the upstream or downstream direction. The multiplexor module 105 multiplexes requisite overhead (e.g., CRC bits, indicator bits, eoc and aoc messages are carried over what is commonly referred to as a sync byte) with the user payload data from a system interface (e.g., ATM or STM). Typically, there are two latency paths in the transmitter (e.g., a fast path and an interleaved path). Note, however, that alternative embodiments may include more than two latency paths, or only one. Additional paths may optionally include either or both an FEC module and an interleaver module. In general, a fast latency path (e.g., including scrambler/FEC module 115a) may be configured to provide lower latency than an interleaved path. On the other hand, an interleaved latency path (e.g., including scrambler/FEC module 115b and interleaver module 120) provides protection against burst errors due to the transmitted signal clipping or impulse noise at the cost of greater latency.

In the embodiment shown, the mux data frames provided by multiplexor 105 to each latency path are subjected to scrambling (e.g., 115a and b) and forward error correction coding (e.g., 115a and b). In addition, the mux data frames provided by multiplexor 105 to the interleaved latency path are subjected to an interleaver function (e.g., 120). The two data streams may then be combined into a data symbol that is input to the constellation encoder (e.g., 130). The constellation encoder can also be programmed or otherwise configured to effect signaling techniques in accordance with the present invention. Before a data symbol is mapped to the subchannel constellations, the subchannel may be appropriately tone ordered (e.g., 125). After constellation encoding, the data is modulated (e.g., 135), buffered (e.g., 140), and converted (e.g., 145) to its analog equivalent to facilitate transmission across the transmission loop.

Variations on the transmitter configuration illustrated in FIG. 1a will be apparent in light of this disclosure, and the present invention is not intended to be limited to any one configuration. For example, other embodiments of the transmitter may include modules not shown in the figure (e.g., an amplifier, line driver, anti-aliasing filter, hybrid circuitry and splitter). Likewise, other embodiments of the transmitter may not include some of the modules shown (e.g., scrambler module). The transmitter components may be implemented in hardware, software, firmware or any combination thereof. For example, each of the components shown in FIG. 1a may be implemented as one or more application specific integrated circuits. Likewise, the components may be implemented as a set (or sets) of software instructions running on one or more digital signal processors. Numerous embodiments and configurations will be apparent in light of this disclosure.

Transmitter Components

The multiplexor module 105 multiplexes the user payload data bytes and overhead bytes (e.g., sync bytes). The multiplexor module 105 may include, for example, a multiplexor for each latency path and separate buffers (e.g., a fast buffer and an interleaved buffer) to store the multiplexed data for each corresponding latency path. In one embodiment, the multiplexor on each of the latency paths (whether downstream or upstream) has a mux data frame rate that is either synchronized to a 4 kHz ADSL DMT symbol rate or to its known fraction or a multiple through a multiplying factor.

A cyclic redundancy check (CRC) can be performed on the multiplexed data for each latency path. Generally, the CRC bits of a particular latency path are carried in a sync byte included in each mux data frame assigned to that latency path after every 68 DMT symbols. Remaining sync bytes that are transmitted over 68 DMT symbols (e.g., an ADSL superframe) carry other overhead related information (e.g., indicator bits, eoc and aoc messages). The multiplexor module 105 outputs mux data frames 206. For the sake of clarity, note that current ADSL standards define a superframe structure. Each superframe is composed of a number of data frames (e.g., 68 data frames numbered 0 through 67). These data frames are encoded and modulated into DMT symbols. Each superframe is followed by a synchronization symbol. In general, such synchronization symbols carry no user or overhead bit-level data and are inserted by the modulator (e.g., 135) to establish superframe boundaries. From the bit-level and user data perspective, the DMT symbol rate is 4000 baud resulting in a period equal to 0.25 milliseconds (in accordance with ADSL standards). However, in order to allow for the insertion of the synchronization symbol, the actual transmitted DMT symbol rate is 69/68×4 000 baud.

In the scrambler and FEC modules 115a and 115b, the scrambler (e.g. when present and operational) operates on the output data buffer of each mux data frame 206 in order to randomize the data pattern as is conventionally done. Such randomizing is for optimizing the transmission performance. Scrambling also minimizes the possibility of repetitive data patterns. Generally, FEC is based on Reed-Solomon (RS) coding. The size (in bytes) of a resulting RS codeword is N_{FEC}=K+R, where the number of check bytes R and codeword size N_{FEC} vary depending on the number of bits assigned to each latency path and the latency requirements associated with each path. K is the number of payload data bytes per RS codeword. The scrambler and FEC modules 115 output the RS codewords, which form the FEC output data frames 212.

The interleaver module 120 performs a conventional interleaving function on the FEC output data frames 212. In one embodiment, the FEC output data frames 212 are convolutionally interleaved in accordance with ADSL standards to a specified interleave depth. Generally, the interleaving process delays each byte of a given FEC output data frame 212 by a different amount. This results in the constellation encoder input data frames 218 containing bytes from a number of different FEC output data frames 212. Given a convolutional interleaving algorithm and the interleaving depths (e.g., powers of 2), the output bytes from the interleaver always occupy distinct time slots when the RS codeword size (N) is odd. When N is an even number of bytes, a dummy byte can be added at the beginning of the RS codeword at the input to the interleaver. The resultant odd-length RS codeword is then convolutionally interleaved. The dummy byte is then removed from the output of the deinterleaver of the corresponding receiver.

The tone ordering module 125 effects a tone ordering algorithm (e.g., vendor specified) to reduce the errors related to clipping caused by the digital-to-analog converter (not shown) of the transmitter. In general, the numbers of bits and the relative gains to be used for every tone are predetermined by the receiver (e.g., by conventional bitloading assignment techniques) and provided to the transmitter. These bit-gain pairs are typically stored in ascending order of frequency (e.g., as designated by tone number) in a bit and gain table. “Tone-ordered” encoding can then be performed, where bits from a fast path are assigned to the tones with the smallest bit assignment, and bits from an interleaved path are assigned to the remaining tones. As is known in the art and illustrated in ADSL standards, tone ordering and bit extraction may be performed with or without trellis coding. Note that because the data from the fast path is not interleaved, the constellation encoder input data frame 218 is identical to the corresponding FEC output data frame 212 (if fast path is the only latency path used).

The encoder and gain scaling module 130, which can be implemented with or without trellis coding, receives the constellation encoder input data frames 218 and encodes them as signal points in signal constellations. This encoding may be based on a given tone ordering. The encoder and gain scaling module 130 may further include a convolutional encoder module for obtaining the coding gain. A number of DMT subchannels 133 (e.g., 255 for downstream, 31 for upstream with appropriate gain scaling) are provided by the encoder and gain scaling module 130 to the IDFT module 135. In one embodiment, the encoder and gain scaling module 130 employs QAM modulation where each constellation signal point has an in-phase component and a quadrature component. Each DMT subchannel 133 corresponds to a constellation. The size of each constellation depends on the bit capacity of the corresponding DMT subchannel. For example, a 64-QAM constellation has 64 signal points. This means that the corresponding DMT subchannel can carry six binary bits (e.g., 2⁶=64). Note that subchannels having larger bit assignments will be associated with a larger constellation size. Likewise, subchannels having smaller bit assignments will be associated with a smaller constellation size. There is one constellation signal point per subchannel per DMT symbol. A DMT symbol, on the other hand, can be associated with a number of subchannels.

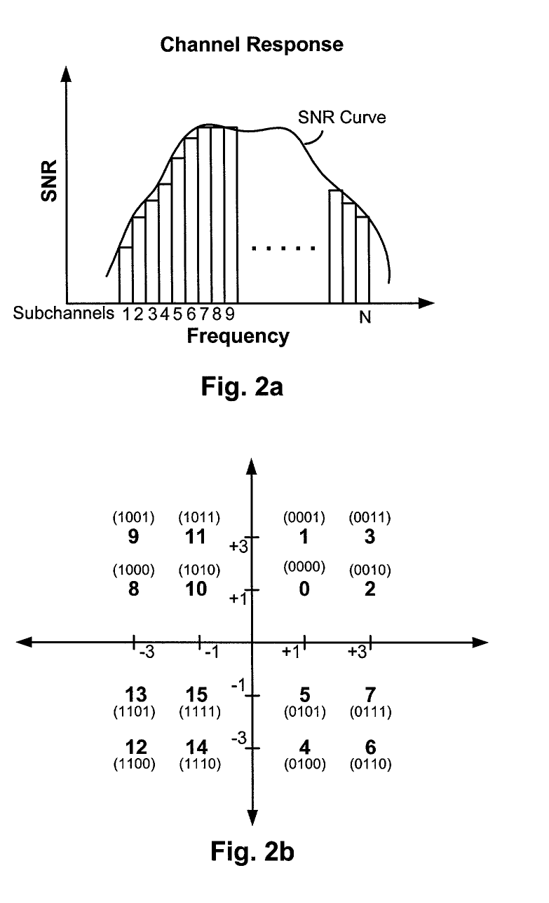

In addition, the encoder and gain scaling module 130 is adapted to effect signaling techniques in accordance with embodiments of the present invention. For example, a signal point in a constellation can be reserved for signaling purposes. Recall that the number of signal points in a constellation for any one subchannel relates to the maximum bit capacity of that subchannel. Further, recall that the maximum number of bits that each subchannel can carry can be determined from the SNR corresponding to that subchannel. Other factors, such as the SNR gap and desired performance margin, may also be used to determine the maximum number of bits that a subchannel can carry. FIG. 2a illustrates a relationship between subchannel capacity and SNR in a multicarrier communication system. The SNR curve or profile is typically characterized by the receiving transceiver when it receives a training signal (e.g., Medley transmission signal period or other channel analysis phase) from the transmitting transceiver during a bitloading training sequence or other initialization procedure. The resulting pattern of subchannel bit capacities is the maximum possible bitloading assignment of the communication channel. This maximum bitloading assignment can then be reduced (e.g., on a subchannel by subchannel basis) to meet the target service requirement.

Signaling with a One Point Constellation

In one embodiment, a DMT subchannel having a one bit capacity (e.g., as identified during initialization when system SNR profile is determined) is reserved for signaling a specific event (e.g., a parameter change) or control (e.g., profile selection). The bit assignment and bit swapping algorithms associated with the DMT system can be notified (e.g., during initialization) of the reserved subchannel so that no data will be assigned to it. By way of example, assume that subchannel 1 of FIG. 2a has a one bit capacity (as determined during the channel analysis phase). Once this one bit subchannel is identified, a message during initialization could be exchanged thereby programming or otherwise designating this subchannel as reserved for signaling purposes. During non-active periods (no event to signal), this one bit subchannel corresponds to a constellation having a signal point having a first state (e.g., logic low or an otherwise inactive state). If the event associated with the one bit subchannel needs to be signaled, then the corresponding constellation signal point can be set by the encoder and gain scaling module 130 to a second state (e.g., logic high or an otherwise active state). The remote receiver will then receive the constellation having the set signal point. The signaled event or control can then take effect after some predetermined turn around period. For example, a signaled parameter change can take place after receipt of the next received symbol. The turn around period can be set as needed to ensure the timeliness of the signaled event.

Signaling with Dense Constellation

In an alternative embodiment, one signal point in a dense constellation (as opposed to a one point constellation) can be reserved for signaling a specific event or control. As stated earlier, a dense constellation typically corresponds to a subchannel having a high SNR. A high SNR translates to high bit capacity, which translates to a dense constellation. For example, assume a subchannel has a capacity of 10 bits. The corresponding constellation for this subchannel would have 1024 signal points (i.e., 2¹⁰). Each of these signal points is represented by a 10 bit data pattern. One of these signal points can be reserved for signaling a reconfiguration event. During normal modem operation, this reserved signal point would never be transmitted (e.g., an inactive state) on the known subchannel negotiated during initialization. However, if the reconfiguration event needs to be signaled, then the associated signal point is transmitted (e.g., an active state) by the encoder and gain scaling module 130. The remote receiver will then receive the constellation having the reserved signal point. The signaled event or control can then take effect after some predetermined turn around period as previously explained.

In this alternative embodiment, if random user data happens to correspond to the reserved signal point, the encoder would force this user data to a pre-established replacement signal point. As such, deliberate errors would be generated. However, these errors can typically be corrected by virtue of forward error correction techniques effected in the physical media-specific transmission convergence layer (e.g., the FEC encoders 115 and FEC decoders 165 of FIGS. 1a and b, respectively). For example, assume that subchannel 7 of FIG. 2a has a bit assignment of 4 bits. In this case, subchannel 7 would be associated with a 16 point constellation as illustrated in FIG. 2b. Each point is represented by a four bit data pattern. Each of the four bit data patterns is represented with an integer label, which is the decimal equivalent of the binary data pattern (e.g., 0000=point 0; 0001=point 1; and 1111=point 15). Further assume that signal point 13 is reserved for signaling purposes, and that its replacement point is signal point 12. In response to the reserved signal point 13 being selected for transmission of a data pattern (non-signaling purposes such as payload data), the encoder and gain scaling module 130 can force that data pattern onto the pre-established replacement signal point 12 thereby introducing a one bit error. Once the remote receiver receives the constellation having this replacement signal point 12, the FEC decoder module can adjust for the known one bit error.

Note that the replacement point can be selected so as to minimize the error introduced. For example, the replacement point can be a point that neighbors (e.g., in the same quadrant) the reserved signal point and is different from the reserved signal point by 1 bit. In such a case, a one bit error is introduced. However, the replacement point need not be in the same quadrant as the reserved signal point, and the amount of known error introduced need not be limited to one bit. For instance, the replacement point for reserved signal point 13 could be signal point 10. Regardless of the known error introduced, it can generally be corrected for by forward error correction techniques. Note that the amount of known error that can be introduced depends on factors such as the complexity of the FEC coding/decoding processes. Errors caused by forcing a data pattern onto a pre-established replacement signal point that cannot be corrected by forward error correction techniques can be corrected at the higher layer application protocols such as TCP/IP through packet retransmission. Thus, probability of occurrence of an uncorrected data error in the system can be designed to be acceptably low.

The inverse discrete Fourier transform (IDFT) module 135 modulates the constellations (e.g., QAM constellations) output by the encoder and gain scaling module 130 on to the corresponding DMT subchannels, and combines all the subchannels together for transmission. The output buffer 140 stores the modulated samples for transmission. The analog front-end 145 converts the samples to analog signals, which may then be filtered, amplified and coupled to the transmission line. Note that the IDFT module 135, the output buffer 140 and the analog front-end 145 may be implemented in conventional technology. Further note that the transmission rate of the transmitter is a function of the total number of bits per symbol and the symbol rate. For example, using 96 subchannels with each subchannel carrying 8 bits per symbol, at a 4 K-baud symbol rate, a transmission rate of 4×96×8=3072 kbit/second is achieved.

General Overview—Receiver

FIG. 1b is a block diagram of an ADSL receiver that is adapted to operate in accordance with one embodiment of the present invention. The receiver includes an analog front-end 147, an input buffer 150, a time domain equalizer (TEQ) 155, a discrete Fourier transform (DFT) module 160, a frequency domain equalizer (FEQ) and decoder module 165, a tone reordering module 170, a deinterleaver module 175, descrambler and forward error correction (FEC) modules 180a and 180b, and a demultiplexor module 185. Generally, the receiver illustrated is based on a model for facilitating understanding of receiver function in conjunction with the transmitter of FIG. 1a. The receiver components may be implemented in hardware, software, firmware or any combination thereof (e.g., application specific integrated circuits, or a set of instructions running on one or more digital signal processors). Note that numerous transmitter-receiver pair configurations will be apparent to one of ordinary skill in the art in light of this disclosure, and the present invention is not intended to be limited to any one such configuration.

Receiver Components

The receiver shown in FIG. 1b may be deployed in either the upstream or downstream direction, and forms a transmitter-receiver pair in conjunction with a remote transmitter. The analog front-end 147 receives the transmitted signal from the transmission line and converts the received analog signal to its digital equivalent. Input buffer 150 receives the digital signal from the analog front-end 147. Time domain equalizer 155 compensates for channel distortion in the time-domain. DFT module 160 separates and demodulates all the subchannels. After the DFT module 160, the frequency domain equalizer and decoder 165 provides further compensation for amplitude and phase distortion for each subchannel. Typically, there is one frequency domain equalizer for each subchannel. In general, equalizer coefficients characterize the distortion of the associated channel and can be used to compensate, or rather, equalize that distortion. Generally, the analog front-end 147, input buffer 150, time domain equalizer 155, frequency domain equalizer 165, and DFT module 160 may be implemented in conventional technology.

With respect to its decoding function, the frequency domain equalizer and decoder 165 is adapted to recover the bit stream from the transmitted constellations as is conventionally done. In addition, decoder 165 operates in conjunction with the encoder and gain scaling module 130 of the remote transmitter to effect signaling techniques in accordance with embodiments of the present invention as described herein. The actual structure of decoder 165 may vary depending on the encoding scheme used by the remote transmitter. For example, the decoder 165 may be a slicer for an uncoded system. On the other hand, decoder 165 may be a Viterbi decoder for a Trellis-code modulation system. Regardless of its structure, decoder 165 detects the received signal and, depending on the signaling technique employed, either looks for the constellation point reserved for signaling purposes or correlates the received signal with the distinct DMT signaling symbols that are used to signal specific events. A reconfiguration event or control function associated with the detected active signal can then be carried out after some predetermined turn around period as previously explained.

In addition, the tone reordering module 170, the deinterleaver module 175, the descrambler and FEC modules 180, and the demultiplexor 185 essentially perform complementary functions associated with the tone ordering module 125, the interleaver module 120, the scrambler and FEC modules 115, and the multiplexor module 105, respectively. Each of these modules can be implemented in conventional technology. Recall that an FEC module 180 may be used to correct for known errors introduced when a signal point of a dense constellation is forced on to a replacement point.

Those skilled in the art will appreciate that the transmitter-receiver pair illustrated by FIGS. 1a and b is only an example of one possible configuration. Other configurations may be comprised of components not specifically represented in the figures (e.g., CRC units). In addition, other configuration may not include all of the components shown in figures (e.g., tone ordering and reordering modules). The configuration of the transmitter-receiver pair is dependent on factors such as the particular application (e.g., ADSL) and the type of multicarrier modulation (e.g., DMT) employed. The present invention is not intended to be limited to any one configuration or application.

Signaling Symbols Based on DMT Sync Symbol

This present invention further identifies a family of distinct DMT symbols that can be used to perform various signaling operations. One embodiment of this family of DMT symbols is based on the DMT sync symbol approach as described in the ITU-T Recommendations G.992.1 and G.992.2.

As explained in the ITU Recommendations (e.g., G.992.1), the DMT sync symbol (sometimes referred to as synchronization symbol or sync frame) is periodically transmitted and permits recovery of the superframe boundary after micro-interruptions that might otherwise force retraining. The DMT sync symbol uses the REVERB pseudo random binary sequence, which includes all the subchannels in the upstream or downstream bands. Typically, the correlation between the REVERB pseudo random binary sequence (PRBS) and its shifted versions is very low. As such, each of these shifted versions can be used to signal a specific event or control function thereby providing a family of 1020 distinct DMT signaling symbols that are as robust as the DMT sync symbol. Each subchannel is modulated to a 4-QAM constellation. The phase of each signal point included in the constellation is selected based on two bits derived from the REVERB pseudo random binary sequence. This phase selection is fixed for every repetition of the sync symbol (e.g., every 69 symbols or 17 milliseconds assuming a 4 KHz symbol rate).

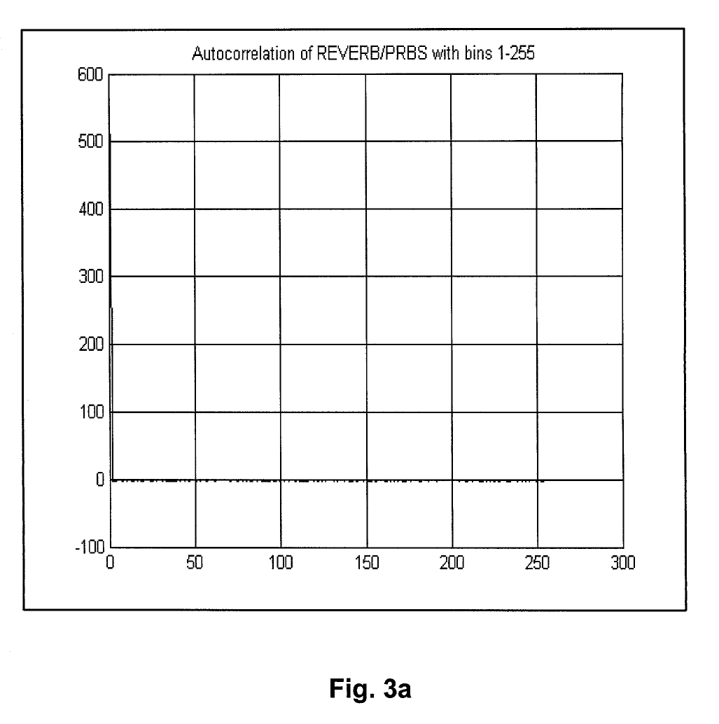

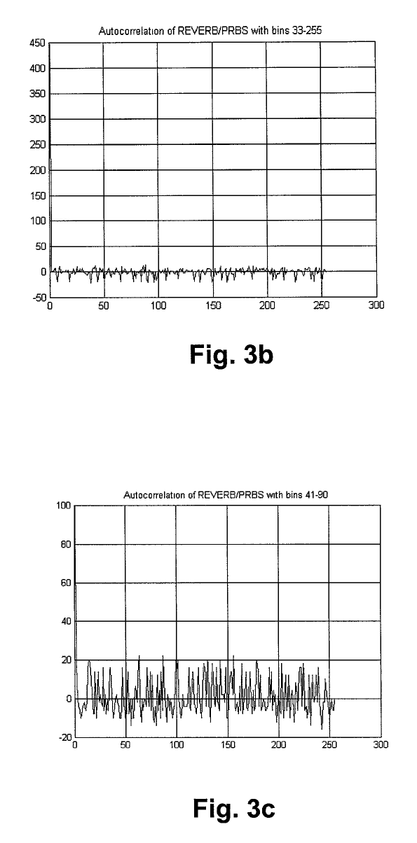

The new signaling symbols in accordance with the present invention can be derived by shifting the REVERB pseudo random binary sequence by k bits, where k=1 to 510. Each shifted version can be used to modulate the 4-QAM constellation of each subchannel. This allows for 510 versions of the shifted REVERB pseudo random binary sequence. These versions, as well as their inverted versions, provide up to 1020 distinct robust signaling symbols that can be used for signaling purposes (e.g., entry and exit from Qmode or online modem reconfiguration). FIG. 3a illustrates the correlation properties of the REVERB pseudo random binary sequence to its entire k (e.g., 0<k<511) bit shifted versions. FIGS. 3b and 3c illustrate the correlation properties of the REVERB pseudo random binary sequence to its shifted versions when a lesser number (e.g., less than 255) of subchannels is used.

Note that the approach of shifting a sequence may also be used with non-REVERB type signals to identify signals (shifted versions of the non-REVERB type signal) having low correlation to one another. Generally stated, signaling signals determined in this manner have useful robustness properties when modems are in an operational state (e.g., low power idle state) that uses a known signal instead of a completely random signal.

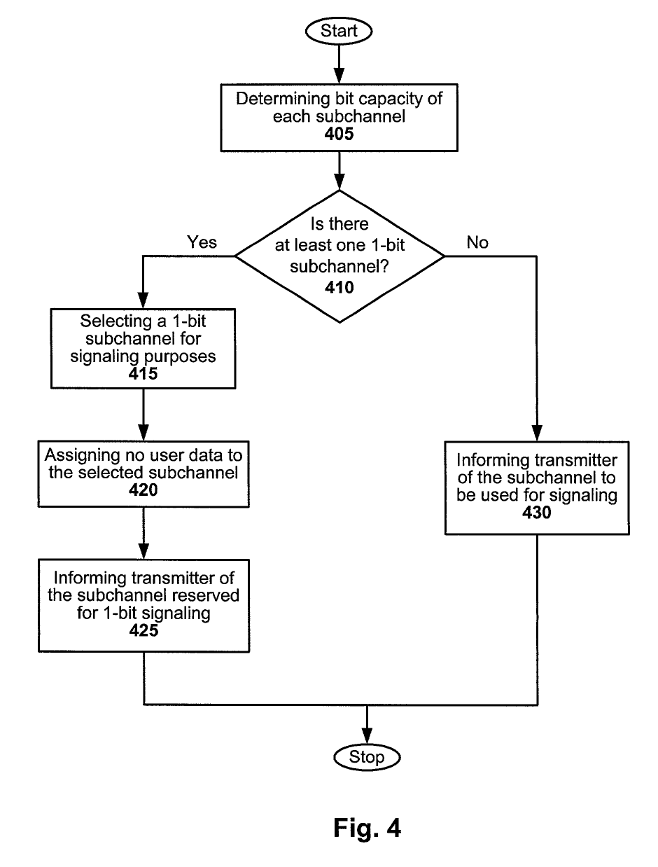

FIG. 4 illustrates a method for performing necessary configuration during initialization in a multicarrier communication system to enable signaling techniques in accordance with one embodiment of the present invention. This method can be employed, for example, by two communicating ADSL modems (transmitter-receiver pair). In one embodiment, the method (or portions thereof) is carried out by software instructions executing on DSP technology (e.g., encoder 130 and decoder 165) or equivalent computing environments.

The method begins with determining 405 the bit capacity of each subchannel included in the multicarrier system. The bit capacity can be determined, for example, after the SNR profile for the overall communication channel has been determined. In one embodiment, the SNR profiles for upstream and downstream are estimated as part of an initialization process referred to as the Medley state. In such an initialization process, known training signals are transmitted over the communication channel to the corresponding receiver. The receiver can then determine the SNR profile of the communication channel, as well as bit assignments of the sub-channels, based on the received signals. The SNR profile can then be communicated back to the corresponding transmitter, and can be used as a map in the bit assignment process.

The method continues with determining 410 whether there is at least one subchannel having a 1-bit capacity. The receiver can make this determination, for example, based on the SNR profile. If there is a 1-bit subchannel, then the method proceeds with selecting 415 or otherwise identifying a 1-bit subchannel as reserved for signaling a particular event or control function. In alternative embodiments, the receiver can provide the SNR profile (or other channel characterizing information) to the transmitter, and the transmitter can then perform steps 410 and 415.

The method further includes assigning 420 no user data (e.g., payload) to the selected subchannel during data mode (e.g., SHOWTIME). Rather, the bit of that subchannel is reserved for signaling purposes. The reserved bit effectively corresponds to a reserved signal point in a constellation associated with the selected subchannel. Note that this step is provided mostly for purposes of clarity, and can be carried out, for example, by the transmitter during the bit assignment process.

The method further includes informing 425 the transmitter identity of the 1-bit subchannel that is reserved for signaling purposes. This assumes that the receiver has performed steps 405 to 415. In an alternative embodiment where the transmitter performs these steps, however, step 425 would involve the transmitter informing the receiver regarding the 1-bit subchannel reserved for signaling purposes. Regardless of where the method functionalities are performed, a 1-bit subchannel reserved for signaling purposes is established for the transmitter-receiver pair. Any particular event or control function can be associated with that established reserved 1-bit subchannel.

If determination 410 indicates that there is no 1-bit subchannel, then the method includes informing 430 the transmitter of the identity of a subchannel to be used for signaling purposes. In such an embodiment, a subchannel having a higher capacity (relative to the other subchannels) could be selected or otherwise identified for signaling purposes. More specifically, recall that a high SNR translates to high bit capacity, which translates to a dense constellation. One signal point in such a dense constellation can be reserved for signaling a specific event or control function. In general, this reserved signal point would never be transmitted (e.g., an inactive state) on the associated subchannel unless signaling becomes necessary. However, if the specific event or control function needs to be signaled, then the associated signal point is transmitted (e.g., an active state) by the encoder. The remote receiver will then receive the constellation having the reserved signal point.

Note that this initialization method may further include establishing a replacement point in the event that user data (non-signaling type data) is randomly assigned to the reserved signal point. In such a case, the user data could be forced by the encoder to the established replacement point in the constellation. This would allow the reserved signal point to be transmitted for signaling purposes only. In such an embodiment, the transmitter-receiver pair would be informed of the established replacement point so that resulting errors could be corrected.

In addition, note that the transmitter can also select a subchannel to be used for signaling purposes. In such an embodiment, step 430 would include informing the receiver of the selected subchannel for signaling purposes (as well as the particular reserved signal point of the constellation associated with that subchannel). Regardless of where the method functionalities are performed, a subchannel for signaling purposes is established for the transmitter-receiver pair. Any particular event or control function can be associated with the reserved signal point of the constellation associated with the selected subchannel.

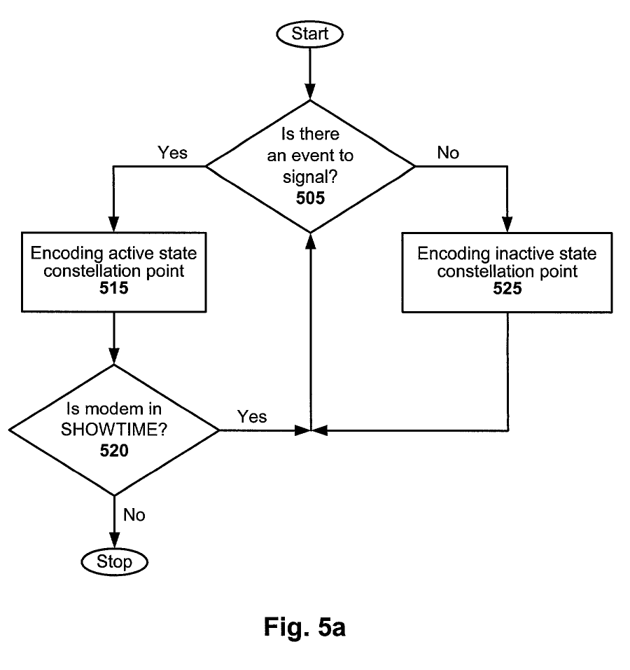

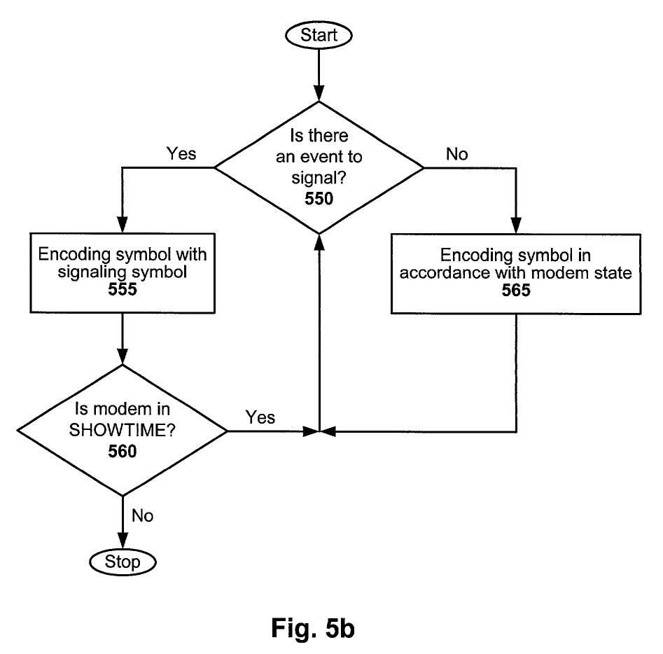

FIG. 5a illustrates a method for signaling an event or control function in a multicarrier communication system in accordance with one embodiment of the present invention. This method can be employed, for example, by the transmitter of a transmitterreceiver pair formed by two communicating ADSL modems. In one embodiment, the method (or portions thereof) is carried out by software instructions executing on DSP technology (e.g., encoder 130) or equivalent computing environments. It is assumed that a subchannel reserved for signaling purposes has been established between the communicating modems (e.g., as described in reference to FIG. 4).

The method begins with determining 505 whether there is an event or control function to signal. Such an event or control function can be, for example, requested by the local management entity, or by the remote modem. Alternatively, such an event or control function can be automatically requested by virtue of the particular protocols being employed. Regardless of the source, such a request can be detected and made available to the encoder of the transmitting modem so that the event or control function associated with that request can be signaled.

If there is no event or control function to signal, then the method further includes encoding 525 an inactive state constellation point. In one embodiment, a 1-bit subchannel is reserved for signaling purposes as previously explained. Here, the one bit of the reserved subchannel corresponds to a reserved constellation signal point that is set to its inactive state. For example, during non-active periods (nothing to signal), this reserved signal point can be set to logic low (or high as the case may be) by the encoder. Note that the transmitter continues to monitor for events or control functions to signal.

In an alternative embodiment, a high capacity subchannel is used for signaling purposes as previously explained. Here, a constellation signal point associated with the subchannel can be selectively transmitted by the encoder. For example, during non-active periods, this reserved signal point would not be transmitted thereby conveying no event or control function to signal. In this alternative embodiment, if random user data (for non-signaling purposes) happens to correspond to the reserved signal point, the encoder would force this data to a pre-established replacement signal point. Known errors generated by this action can be corrected by forward error correction techniques. Thus, a high capacity subchannel used for signaling purposes should generally be assigned to a path that is subjected to forward error correction, or is otherwise adapted for error correction. Note that bit loading assignment and bit swapping algorithms can be programmed to effect this selective use of the reserved signal point and replacement point scheme.

If determination 505 indicates that there is an event or control function to signal, then the method further includes encoding 515 an active state constellation point. In the embodiment where a 1-bit subchannel is reserved for signaling purposes, the corresponding reserved constellation signal point is set to its active state (e.g., logic high). This active state can generally be referred to as signaling data. In the case of a high capacity subchannel, if it becomes appropriate to signal the event or control function associated with the reserved signal point, then that signal point can be made active by transmitting it. Here, the presence of the reserved signal point in a transmitted constellation acts as signaling data.

The method may further include determining 520 whether the transmitting modem is in a data mode, such as SHOWTIME. If not, then the method terminates. However, if the modem is in a data mode, then the modem continues to monitor for events or control functions to signal.

FIG. 5b illustrates a method for signaling an event or control function in a multicarrier communication system in accordance with another embodiment of the present invention. This method may be implemented, for example, by the transmitter of a transmitter-receiver pair formed by two communicating ADSL modems. In one embodiment, this method allows an event or control signal to be transmitted once every superframe by using the sync symbol. For instance, assume a superframe includes 68 symbols each having a 0.25 millisecond period. In such an embodiment, an event or control signal can be transmitted approximately every 17 milliseconds (assuming the sync symbol follows every superframe). It will be apparent in light of this disclosure that symbols other than the sync symbol can be used to effect this method.

The method begins with determining 550 whether there is an event or control function to signal as described in reference to FIG. 5a. If there is no event or control function to signal, then the method further includes encoding 565 the symbol in accordance with the present modem state of operation (e.g., with non-signaling data, such as the REVERB data pattern). In response to receiving the transmitted symbol, the receiver can decode and interpret the non-signaling data associated with the symbol, and proceed accordingly. Note that the transmitter continues to monitor for events or control functions to signal.

If determination 550 indicates that there is an event or control function to signal, then the method further includes encoding 555 the symbol with the corresponding signaling symbol data pattern. Here, the encoded symbol effectively becomes a signaling symbol. In one embodiment, up to 1020 data patterns distinct from the DMT sync symbol data pattern can be predetermined by shifting the REVERB pseudo random binary sequence by k bits (where k=1 to 510) as previously explained. The shifted versions can be stored or otherwise made accessible by the transmitter, and indexed based on their degree of correlation to the DMT sync symbol, although any one of these shifted sequences typically has low correlation to the DMT sync symbol. Likewise, the shifted versions can be indexed according to the particular event or control function that each version is used to signal. Regardless, the data pattern corresponding to the event or control function to be signaled is retrieved or otherwise obtained, and encoded into the symbol thereby producing a distinct signaling symbol.

Note that the actual content (e.g., data pattern) of the transmitted signaling symbol can be associated with a specific event or control function. For example, the encoder can encode the signaling symbol with a data pattern selected from a family of such patterns, each member of the family associated with a particular event or control function that is generally known by the communicating modems. In this sense, the signaling symbol can be used to signal numerous events or control functions. In another sense, a symbol that is used as a signaling symbol has its normal data pattern (e.g., REVERB data pattern of a DMT sync symbol) replaced by a data pattern that is reserved for signaling purposes (e.g. a shifted version of the DMT sync symbol data pattern).

The distinct signaling symbol is transmitted to the receiver of the transmitter-receiver pair, and the receiver can then decode and interpret the signaling symbol's data pattern and then effect the associated event or control function after some pre-established turn around time. Assume, for example, that receipt of the signaling symbol signals a reconfiguration of a transmitter-receiver pair in a DMT-based system. On receipt of the next DMT symbol, both the transmitter and the receiver can change to a configuration as agreed upon through the given line reconfiguration protocol. Note that turn around periods other than the next DMT symbol can be used. For example, the reconfiguration can take place upon receipt of the next fifth DMT symbol. The receipt of the distinct DMT symbol can be detected, for example, by the decoder module (e.g., decoder 165) of the receiver of the transmitter-receiver pair.

The method may further include determining 560 whether the transmitting modem is in a data mode, such as SHOWTIME. If not, then the method terminates. However, if the modem is in a data mode, then the modem continues to monitor for events or control functions to signal.

It is assumed that a symbol to be used for signaling purposes has been established between the communicating modems, as well as the association of the distinct data patterns with particular events or control functions. Such can be established, for example, during handshaking procedures such as those described in ITU Recommendation 994.1. Generally, such handshaking procedures allow communicating modems to exchange information regarding their respective capabilities and protocols. Alternatively, the signaling symbol, as well as the data pattern/event-control function relationships, could be established during initialization. Regardless, each communicating modem is informed of the signaling symbol scheme before entering data mode (such as SHOWTIME).

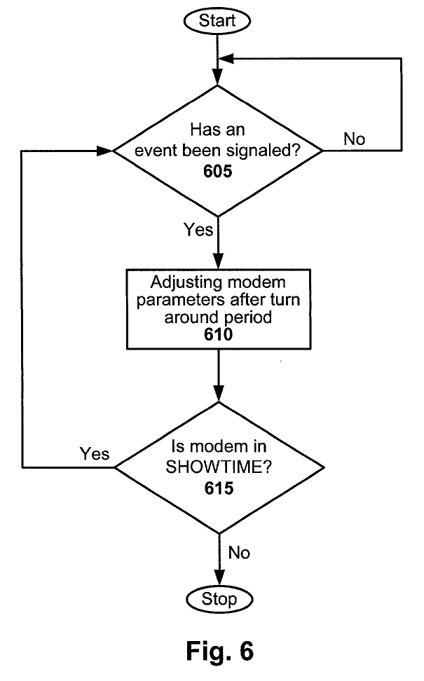

FIG. 6 illustrates a method for signaling an event or control function in a multicarrier communication system in accordance with another embodiment of the present invention. This method can be employed, for example, by the receiver of a transmitter-receiver pair formed by two communicating ADSL modems. In one embodiment, the method (or portions thereof) is carried out by software instructions executing on DSP technology (e.g., decoder 165) or equivalent computing environments. It is assumed that a signaling scheme has been established between the communicating modems (e.g., as described in reference to FIG. 5a or 5b).

The method begins with determining 605 whether an event or control function has been signaled. In one embodiment, the decoder of the receiver makes this determination by decoding received information, and detecting that a constellation point reserved for signaling purposes is in its active state (as opposed to its inactive state when there is nothing to signal). Note that the reserved signal point is associated with a subchannel of the multicarrier system. As previously explained, that subchannel may be a 1-bit subchannel or a high capacity subchannel (in reference to other subchannels of the system).

Alternatively, receipt of a distinct signaling symbol can be detected based on its distinct data pattern. This distinct data pattern can effectively be reserved for signaling a particular event or control function. The distinct signaling symbol can be, for example, a sync symbol which has had its sync symbol data pattern replaced by the data pattern reserved for signaling the particular event or control function. Recall that a family of such distinct data patterns can be pre-established and associated with respective events of control functions for signaling purposes as previously explained. Note that any case, if nothing is being signaled, then the method continues to monitor for event or control function signals.

If determination 605 indicates that an event or control function has been signaled, then the method further includes adjusting 610 the modem parameters of the transmitter-receiver pair to effect that event or control function. As previously explained, a turn around period in which the parameter changes take effect can be pre-established. This pre-established turn around period allows both modems to effect the requisite parameter changes substantially at the same time or in an otherwise synchronized fashion.

The method may further include determining 615 whether the transmitting modem is in a data mode, such as SHOWTIME. If not, then the method terminates. However, if the modem is in a data mode, then the modem continues to monitor for events or control functions to signal.

The foregoing description of the embodiments of the invention has been presented for the purposes of illustration and description. It is not intended to be exhaustive or to limit the invention to the precise form disclosed. Many modifications and variations are possible in light of the above teaching. For example, the principles and concepts underlying the present invention may be employed by a number of multicarrier communication systems and need not be limited to ADSL DMT systems. It is intended that the scope of the invention be limited not by this detailed description, but rather by the claims appended hereto.

What is claimed is:

1. A method for signaling an event or control function in a multicarrier communication system, the method comprising:
determining that there is an event or control function to signal;
encoding an active state signal point in a constellation associated with a subchannel, the signal point being reserved for signaling purposes; and
transmitting the constellation to signal the event or control function during data mode.

2. The method of claim 1 wherein at least a portion of the method is carried out by software instructions executing on digital signal processor (DSP) technology.

3. The method of claim 1 wherein the multicarrier communication system is a discrete multitone (DMT) system.

4. The method of claim 1 wherein the subchannel has a one bit capacity.

5. The method of claim 1 wherein the subchannel has a bit capacity of more than one bit, and is assigned to a latency path that is subjected to error correction.

6. The method of claim 1 wherein the signal point reserved for signaling purposes is established during an initialization procedure before entering the data mode.

7. The method of claim 1 wherein any non-signaling data pattern that is randomly assigned to the signal point reserved for signaling purposes is forced on to a pre-established replacement signal point.

8. The method of claim 7 wherein bit loading assignment and bit swapping algorithms associated with the multicarrier communication system are programmed to effect selective use of the signal point reserved for signaling purposes and the pre-established replacement signal point.

9. The method of claim 7 wherein known errors generated by forcing data on to the pre-established replacement signal point are corrected by error correction techniques.

10. The method of claim 7 wherein the pre-established replacement signal is established during an initialization procedure before entering the data mode.

11. The method of claim 1 wherein the step of encoding an active state signal point includes changing the signal point from an inactive state to an active state.

12. The method of claim 1 wherein in response to determining that there is no event or control function to signal, the signal point reserved for signaling purposes is encoded to its inactive state.

13. The method of claim 1 wherein the signaled event or control function takes effect after a predetermined turn around period.

14. A method for signaling an event or control function in a multicarrier communication system, the method comprising:
determining that there is an event or control function to signal;
encoding a symbol associated with a first symbol data pattern with a data pattern that is distinct from the first symbol data pattern and its inversion thereby producing a distinct signaling symbol; and
transmitting the distinct signaling symbol to signal the event or control function during data mode.

15. The method of claim 14 wherein at least a portion of the method is carried out by software instructions executing on digital signal processor (DSP) technology.

16. The method of claim 14 wherein the multicarrier communication system is a discrete multitone (DMT) system.

17. The method of claim 14 wherein the data pattern that is distinct from the first symbol data pattern is associated with the event or control function before the communication system enters the data mode.

18. The method of claim 14 wherein the symbol associated with the first symbol data pattern is a sync symbol, and the first symbol data pattern is a sync symbol data pattern.

19. The method of claim 14 wherein in response to determining that there is no event or control function to signal, the method further comprises:
encoding the symbol associated with the first symbol data pattern with the first symbol data pattern.

20. The method of claim 14 wherein the signaled event or control function takes effect after a predetermined turn around period.

21. The method of claim 14 wherein the symbol associated with the first symbol data pattern is transmitted once every superframe.

22. The method of claim 14 wherein the data pattern that is distinct from the first symbol data pattern and its inversion is a shifted version of the first symbol data pattern.

23. A method for signaling an event or control function in a multicarrier communication system operating in data mode, the method comprising:
decoding received information and detecting a constellation signal point reserved for signaling purposes in its active state; and
adjusting parameters of the system to effect the event or control function after a pre-established turn around period.

24. The method of claim 23 wherein the multicarrier communication system is a discrete multitone (DMT) system.

25. The method of claim 23 wherein the signal point reserved for signaling purposes is associated with a subchannel having a one bit capacity.

26. The method of claim 23 wherein the signal point reserved for signaling purposes is associated with a subchannel having a bit capacity of more than one bit, and is assigned to a latency path that is subjected to error correction.

27. The method of claim 23 wherein the signal point reserved for signaling purposes is established during an initialization procedure before entering the data mode.

28. The method of claim 23 further comprising:
correcting with forward error correction known errors generated by forcing non-signaling data randomly assigned to the signal point reserved for signaling purposes on to a pre-established replacement signal point.

29. The method of claim 28 wherein bit loading assignment and bit swapping algorithms associated with the multicarrier communication system are programmed to effect selective use of the signal point reserved for signaling purposes and the pre-established replacement signal point.

30. The method of claim 28 wherein the pre-established replacement signal is established during an initialization procedure before entering the data mode.

31. The method of claim 23 wherein the parameters include modem configuration parameters associated width the event or control function being signaled.

32. A method for signaling an event or control function in a multicarrier communication system operating in data mode, the method comprising:
decoding a distinct signaling symbol having a data pattern reserved for signaling an event or control function; and
adjusting parameters of the system to effect the event or control function after a pre-established turn around period.

33. The method of claim 32 wherein the multicarrier communication system is a discrete multitone (DMT) system.

34. The method of claim 32 wherein the data pattern reserved for signaling the event or control function is associated with the event or control function before the communication system enters the data mode.

35. The method of claim 32 wherein the distinct signaling symbol is a sync symbol which has had its sync symbol data pattern replaced by the data pattern reserved for signaling the event or control function.

36. The method of claim 32 wherein the distinct signaling symbol is transmitted once every superframe.

37. The method of claim 32 wherein the data pattern reserved for signaling the event or control function is a shifted version of a sync symbol data pattern.

38. A modem adapted to signal an event or control function in a multicarrier communication system during data mode, the modem comprising:
an encoder module adapted to encode an active state signal point in a constellation associated with a subchannel, the signal point being reserved for signaling purposes.

39. The modem of claim 38 wherein the signal point reserved for signaling purposes is established during an initialization procedure before entering the data mode.

40. The modem of claim 38 wherein any non-signaling data pattern that is randomly assigned to the signal point reserved for signaling purposes is forced on to a pre-established replacement signal point.

41. The modem of claim 40 wherein bit loading assignment and bit swapping algorithms associated with the multicarrier communication system are programmed to effect selective use of the signal point reserved for signaling purposes and the preestablished replacement signal point.

42. The modem of claim 40 wherein known errors generated by forcing data on to the pre-established replacement signal point are corrected by error correction techniques.

43. The modem of claim 40 wherein the pre-established replacement signal is established during an initialization procedure before entering the data mode.

44. A modem adapted to signal an event or control function in a multicarrier communication system during data mode, the modem comprising:
an encoder module adapted to encode a symbol associated with a first symbol data pattern with a data pattern that is distinct from the first symbol data pattern and its inversion thereby producing a distinct signaling symbol.

45. The modem of claim 44 wherein the data pattern that is distinct from the first symbol data pattern is associated with the event or control function before the communication system enters the data mode.

46. The modem of claim 44 wherein the symbol associated with the first symbol data pattern is a sync symbol, and the first symbol data pattern is a sync symbol data pattern.

47. The modem of claim 44 wherein the signaled event or control function takes effect after a predetermined turn around period.

48. The modem of claim 44 wherein the symbol associated with the first symbol data pattern is transmitted once every superframe.

49. The modem of claim 44 wherein the data pattern that is distinct from the first symbol data pattern and its inversion is a shifted version of the first symbol data pattern.

50. A modem adapted to signal an event or control function in a multicarrier communication system during data mode, the modem comprising:
a decoder module adapted to decode received information and to detect a constellation signal point reserved for signaling purposes in its active state.

51. A modem adapted to signal an event or control function in a multicarrier communication system during data mode, the modem comprising:
a decoder module adapted to decode a distinct signaling symbol having a data pattern reserved for signaling an event or control function, wherein the distinct signaling symbol is a symbol which has had its symbol data pattern replaced by the data pattern reserved for signaling the event or control function.

52. A method for performing initialization in a multicarrier communication system including a transmitter-receiver pair, the method comprising:
determining the bit capacity of each subchannel included in the multicarrier system; and
establishing, for the transmitter-receiver pair, a 1-bit subchannel as reserved for signaling a particular event or control function.

53. A method for performing initialization in a multicarrier communication system including a transmitter-receiver pair, the method comprising:
determining the bit capacity of each subchannel included in the multicarrier system; and
establishing, for the transmitter-receiver pair, a constellation signal point as reserved for signaling a particular event or control function.
